(19) United States
(12) Patent Application Publication
(10) Pub. No.: US 2019/0069569 A1
(43) Pub. Date: Mar. 7, 2019

(54) COMPOSITIONS AND METHODS FOR TREATING PRODUCE

(71) Applicant: Lotus Innovative Health, Ltd., Castro Valley, CA (US)

(72) Inventors: Kin-Ping Wong, Castro Valley, CA (US); Ming-Chung Wong, Castro Valley, CA (US); Evan Zender Wong, Menlo Park, CA (US)

(21) Appl. No.: 16/120,208

(22) Filed: Aug. 31, 2018

(30) Foreign Application Priority Data
Sep. 1, 2017 (CN) 201710780751.3

(51) Int. Cl. A23B 7/154; A01N 45/00; A01N 37/06; A01N 63/00; A23B 7/16

(52) U.S. Cl. CPC A23B 7/154; A01N 45/00; A23B 7/16; A01N 63/00; A01N 37/06

(57) ABSTRACT

The present invention discloses the use of winter melon wax as a preservative and an antimicrobial agent. In addition, the present invention also discloses a kind of powder of artificial winter melon wax, which is obtained by spray drying the solution of following components with ratios by weight: 30-55% triterpenenol, 10%-20% triterpenenol acetate and 35-60% wax. Experiments proved that the natural winter melon wax and the artificial Winter melon wax powder prepared by the invention had antiseptic and anti-microbial effects, could significantly improve the shelf life of fruits, and had a promoting effect on wound healing.

### CROSS-REFERENCE TO RELATED APPLICATIONS

This application claims priority to Chinese Application No. 201710780751.3 (Sequence number: 2017090101544590) entitled “Composition of a Novel and Natural Preservative for Fruits and Grains and Methods of Using the same,” filed Sep. 1, 2017, which is incorporated by reference in its entirety herein.

### BACKGROUND

### Field of the Art

The present subject matter relates generally to preservatives. More specifically, the present subject matter relates to compositions and methods for treating various items with a preservative to increase their shelf life.

### Discussion of the State of the Art

The winter melon (Benincasa hispida) is also called Donggua, Pillow melon, White Winter Melon, Water Ganoderma, Ganoderma lucidum, White Melon, Pugua or Big Winter Melon. Because the fruits are huge, the melons grow on vines and can be eaten as a vegetable after ripening.

It is the only member of the Benincasa savi. The fruit is covered with hair when it is immature. The immature winter melon has thick white flesh and tastes a bit sweet. When ripe, the fruit loses its hair and forms a waxy layer, and hence it is given an English name of wax gourd. This layer gives the melon a long shelf life. The winter melon wax contains tiny rod bundles and is mainly composed of triterpenoids (TT, ˜50%) and triterpenoid acetates (TTA, ˜18%). A winter melon may grow to 80 cm long. Although it is also called “melon”, its whole plant part has no sweet taste. Native to South Asia and Southeast Asia, the winter melon is widely grown in Asia.

### The Preservative

Preservatives are natural or synthetic chemicals that are added to products such as foods, crops, pharmaceuticals, biological samples, wood, etc. to prevent decomposition by microbial growth or undesirable chemical changes.

Food preservation is a treatment method for preserving the edible and nutritional value of food. The main effort is to prevent or greatly reduce corruption and prevent food borne illness (e. g., by pickling, cooling, cooking). However, some methods add special functions and preserve foods (such as cheese, wine) by using beneficial bacteria, yeast or fungi. Maintaining or producing nutritional value, taste and taste are extremely important in preserving the value of food, whereas this is related to the cultural background, such as the characteristics of a food suitable for people in one cultural background but not necessarily for people in another cultural background. Preservation usually involves preventing the growth of bacteria, fungi and other microorganisms, as well as delaying the rancidity caused by fat oxidation. It also includes processes that inhibit natural aging and discoloration that occur during food preparation, such as enzymatic browning in apples that can cause browning when the apple is cut. Some preservation methods require sealing after the food is processed to prevent re-contamination of microorganisms. Others, such as drying, can store food for a longer period of time without any special containment.

Common methods for food preservation include drying, spray drying, freeze drying, freezing, vacuum packaging, canned food, irradiation, addition of preservatives or inert gases such as carbon dioxide. Other methods not only help to preserve food, but also provide aroma, including pickling, smoking, preservation in syrup or alcohol, sugar crystallization, and curing.

Preservatives in food additives can be used alone or in combination with other methods of food preservation. The preservative may be an antimicrobial preservative which inhibits bacteria and fungi, or an antioxidant such as an oxygen absorber which inhibits oxidation of food ingredients. Common antimicrobial preservatives include calcium propionate, sodium nitrate, sodium nitrite, sulfites (sulfur dioxide, sodium bisulfite, potassium bisulfite, sulfurous acid, etc.) and disodium EDTA. Common antioxidants include BHT (butylatedhydroxytoluene) and BHA (butylatedhydroxyanisole). Other preservatives include formaldehyde (usually in solution), glutaraldehyde (killing insects), ethanol and chloromethane. The benefits and safety of artificial food additives (including preservatives) are the subject of debate between academia and people who oversee food science and toxicology.

Antioxidants are widely used in foods including, but not limited to, meat, poultry, fats, oils, margarines, fish, seafood and baked goods to inhibit the degradation of fats and oils or their oxidation products. Currently dominant in the market are synthetic preservatives such as BHT and BHA. These are beginning to be replaced by natural preservatives such as rosemary, tea extract, tocopherol and ascorbate. However, the high prices of natural preservatives limit their widespread use in foods, also leads to the continued use of synthetic preservatives.

Antimicrobial agents are also used as preservatives in the food industry to extend the shelf life of products, improve product safety, maintain product quality, reduce processing costs, and increase the ability to distribute products across complex supply chains worldwide. Due to consumer concerns about the use of synthetic additives, the market for synthetic antimicrobials is declining.

Natural substances such as salt, sugar, vinegar and diatomaceous earth are also used as traditional preservatives. Another group of preservatives is targeted to enzymes that are still metabolically active when the fruits and vegetables are received. For example, citric acid and ascorbic acid from lemon or other citrus juices inhibit the activity of phenolases that brown the surface of cut apples and potatoes.

Rancidity is the breakdown of fat, oil and other lipids by hydrolysis or oxidation or a combination of both. Hydrolysis separates the fatty acid chain from the glycerol backbone of the glyceride. These free fatty acids can then undergo further auto-oxidation. Oxidation produces unsaturated fats primarily through free radical mediated processes. These chemical processes produce highly reactive molecules in rancid foods and oils that produce unpleasant and toxic odors and tastes. These chemical processes can also destroy the nutrients of the food. In some cases, rancidity and vitamin damage occur very quickly.

When fatty materials are exposed to air, their unsaturated components are converted to hydroperoxides which decompose into volatile aldehydes, esters, alcohols, ketones and hydrocarbons, some of which have an unpleasant odor. The butter becomes rancid by the aforementioned process and hydrolysis, which releases volatile and odorous acids, particularly butyric acid. Saturated fatty acids, such as tallow, are resistant to oxidation and rarely rancid at room temperature.

Factors that accelerate fat oxidation include trace metals (iron, zinc, etc.), salt, light, water, bacteria and mold. By using the spices, such as sage and rosemary, and store the fat and oil in a place that is rarely exposed to oxygen or free radicals, in a cool, dark place, fat oxidation can be inhibited, because heat and light accelerate the speed of the reaction between fat and oxygen.

Antioxidants are usually added to fat-containing foods to delay rancidity due to oxidation. Natural antioxidants include flavonoids, polyphenols, ascorbic acid (vitamin C) and tocopherol (vitamin E). Synthetic antioxidants include BHA, BHT, n-propyl 3,4,5-trihydroxybenzoate (also known as gallic acid propyl ester) and ethoxyquin. The effects of natural antioxidants are often short-lived, so synthetic antioxidants are preferred when longer shelf life is required. The effectiveness of water-soluble antioxidants is limited in preventing direct oxidation in fats, but is of great value in intercepting free radicals in the aqueous portion of foods.

### Synthetic Preservatives

Some modern synthetic preservatives that have been shown to cause respiratory or other health problems have become controversial. Some studies have pointed out that synthetic preservatives and artificial colorants exacerbate the symptoms of ADD & ADHD in affected people. Several major studies have shown that when artificial additions, including preservatives, are removed from school food programs, most non-ADD student groups have improved academic performance and reduced disciplinary problems. Adding allergenic preservatives to foods or drugs can cause anaphylactic shock in susceptible populations, without emergency treatment the shock is often fatal within minutes.

Therefore, the use of natural antioxidants has become a trend today. Plants contain phytochemicals, many of which are known to have antioxidant properties. Polyphenols are a collective term for a group of phytochemicals, including flavonoids, anthocyanins and phenolic acids that are naturally found in a wide range of plants. Most are colored, giving the color found in the fruit and the color of other parts of the plant. Its biological activity is mainly as an antioxidant, which helps protect plants from tissue damage and microbial attack.

The literature on plant phenolics has been extensively studied for various polyphenols associated with different plant species. The physiological effects of the uptake of many of these polyphenols have also been examined in the clinic, and they have been found to exhibit not only antioxidative activity but also anti-inflammatory and vasodilating properties.

The high anti-oxidant levels and health promoting properties of frequently eaten foods and drunk beverages, such as coffee, tea, cocoa (chocolate), red wine, berries (blueberries, blackberries, strawberries) and fruits (mangosteen, noni, pomegranate, acai, grapes) are currently being demonstrated and sold.

In general, plants and plant products have much higher antioxidant contents than animal foods. Certain spices, berries, fruits, nuts, chocolate-containing products, vegetables and cereals are good sources of dietary antioxidants. In addition, coffee, green and black tea, red wine and a variety of berries and juices are also good sources of antioxidants.

Antioxidant syrups and powders whose sources are described above have been widely used in the food industry as food components and additives. High polyphenol antioxidant syrups and powders (such as Vinlifeextracted from grapes by Tarac technology in southern Australia and polyphenolic compounds from California) have been used in chocolate (cocoa farm, Melbourne, Australia), cocoa, tea And ice cream (Wendi Vinlife Ice Cream, Australia) and other products. However, these food ingredients are often used to increase the antioxidant content of foods to provide a beneficial health effect, rather than as a food preservative.

### Antimicrobial Agent

Formulations capable of killing or inhibiting microorganisms can be classified as disinfectants, antibacterial agents or antibiotics. Antibiotics are molecules produced by a microorganism that kill (sterilize) or inhibit (bacteriostatic) other microorganisms. Preservatives and disinfectants are commercially prepared chemicals that differ in that the antimicrobial agent can be exposed to the mucosal surface for at least a short period of time, and the disinfectant cannot, as they can cause harm.

### SUMMARY

It is an object of the present invention to provide a compound derived from winter melon which has antiseptic and antimicrobial properties.

In order to achieve the above object, the present invention adopts the following technical measures:

According to a first aspect of the invention, the application of winter melon wax (WMW) in the preparation of a preservative and an antimicrobial agent is provided.

Wherein it is preferable to add an effective amount of preservative of winter melon wax is added into food, a cosmetic or a medicine.

According to another aspect of the present invention, an artificial WMW powder obtained by spray drying the solution of following components with ratios by weight: 30-55% triterpenenol, 10%-20% triterpenenol acetate and 35-60% wax is provided.

Wherein, preferably the triterpenenol is Betulin or a structural analog thereof, the chemical structural formula of Betulin is shown in FIG. 1 (Formula I), and the triterpenenol acetate is α-amyrin acetate or its structural analog thereof, the chemical structural formula of α-amyrin acetate is shown in the formula illustrated in FIG. 1 (Formula II).

Wherein, preferably the wax is beeswax.

Further, the present invention also provides the application of the artificial WMW powder in the preparation of a preservative and an antimicrobial agent.

Wherein, preferably an effective preservative amount of artificial WMW powder is added to food, cosmetic or medicine.

The compounds used in this aspect of the invention have both antioxidant and antimicrobial properties. In the previous art, different preservatives were required to achieve different characteristics.

The term “effective amount of preservative” means a minimized amount which is capable of substantially inhibiting rancidity of fats and oils (antioxidant properties) and/or minimized amount which is capable of substantially inhibiting the growth of microorganisms (antimicrobial). The exact amount used will depend on the particular composition and the desired shelf life. Preferably, the amount used is from 0.0001 to 5%, more preferably from 0.01 to 2.5% by weight of the total composition.

The preservative of the present invention can be added into food, cosmetic or medicine (intestinal and parenteral products) by mixing, infusing, injecting, mixing, dispersing, refining, emulsifying, dipping, spraying, agglomerating and kneading, directly and without further modification.

The term “food” as used herein includes any edible product such as, but not limited to, candy, supplements, snacks (sweet and salty), and cocoa, spices, beverages including coffee (instant and pre-mixed), nutraceuticals, dietary supplements and different food dosage forms, including supplements for animal health and nutrition, dairy products such as: milk, yogurt, ice cream, bakery products and food seasonings and animal feed. The preservative of the present invention can be added to foods, including but not limited to:

Dairy products such as cheese, butter, milk and other dairy beverages, jam and dairy blends, ice cream and yogurt;

Fat-based products such as margarine, jam, mayonnaise, shortening, cooking and frying oils and dressings;

Cereal-based products—including cereals (such as bread and pasta), which are cooked, roasted or otherwise processed;

Pastries—such as chocolate, candy, chewing gum, desserts, non-dairy ingredients, sorbets, icing and other fillings;

Sports nutrition products, including powders, pre-mixes, juices, energy bars, isotonic beverages and gums, starch-based or pectin jelly;

Beverages—hot or cold (coffee, tea, cocoa, cereals-, chicory- and other plant extract-based drinks), alcoholic or non-alcoholic beverages, including cola and other beverages, juice drinks, nutritional supplements, instant premixing and meal replacement beverage; and

Other product displays—including eggs and egg products, processed foods such as soups, prepared dough.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a chemical structure for triterpenenol and triterpenenol acetate in accordance with one embodiment of the invention.

FIG. 2a illustrate an exemplary Winter melon wax (“WMW”) in accordance with one embodiment of the invention as observed using an electronic microscope. The magnification illustrated in this figure is at 5000×.

FIG. 2b illustrate an exemplary Winter melon wax (“WMW”) in accordance with one embodiment of the invention as observed using an electronic microscope. The magnification illustrated in this figure is at 7000×.

FIG. 2c illustrate an exemplary Winter melon wax (“WMW”) in accordance with one embodiment of the invention as observed using an electronic microscope. The magnification illustrated in this figure is at 20000×.

FIG. 3a illustrates the antiseptic effect of WMW on lemon fruit in accordance with one embodiment of the invention. Item 1 in FIG. 3a illustrates a fresh lemon, item 2 in FIG. 3a illustrates a lemon after 15 to 20 without any application of WMW, and item 3 in FIG. 3a illustrates a lemon after 15 to 20 days with an application of WMW.

FIG. 3b illustrates the antiseptic effect of WMW on lemon fruit in accordance with one embodiment of the invention. Item 1 in FIG. 3b illustrates a partially decayed lemon, item 2 in FIG. 3b illustrates a partially decaled lemon after 15 to 20 without any application of WMW, and item 3 in FIG. 3b illustrates a partially decayed lemon after 15 to 20 days with an application of WMW.

FIG. 3c illustrates the antiseptic effect of WMW on orange fruit in accordance with one embodiment of the invention. Item 1 in FIG. 3c illustrates a partially decayed orange, item 2 in FIG. 3c illustrates a partially decaled orange after 15 to 20 without any application of WMW, and item 3 in FIG. 3c illustrates a partially decayed orange after 15 to 20 days with an application of WMW.

FIG. 3d illustrates the antiseptic effect of WMW on orange fruit in accordance with one embodiment of the invention. Item 1 in FIG. 3d illustrates a fresh orange, item 2 in FIG. 3d illustrates an orange after 15 to 20 without any application of WMW, and item 3 in FIG. 3d illustrates an orange after 15 to 20 days with an application of WMW.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

A description of an aspect with several elements does not imply that all such components are required. To the contrary, a variety of optional elements may be described to illustrate a wide variety of possible embodiments and in order to more fully illustrate one or more embodiments. Similarly, although process steps, and method steps or the like may be described in a sequential order, such process steps, and method steps may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single article is described herein, it will be readily apparent that more than one article may be used in place of a single article. Similarly, where more than one article is described herein, it will be readily apparent that a single article may be used in place of the more than one article.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### EMBODIMENTS

The invention will be further described in conjunction with the specific embodiment, through the description advantages and features of the invention will become more apparent. However, these examples are merely exemplary and do not constitute any limitation on the scope of the invention. It should be understood by those skilled in the art that the details and forms of the present invention may be modified or substituted without departing from the spirit and scope of the invention, and such modifications and substitutions fall within the scope of the present invention.

### Embodiment 1: Preparation and Analysis of Winter Melon Wax (WMW) Powder

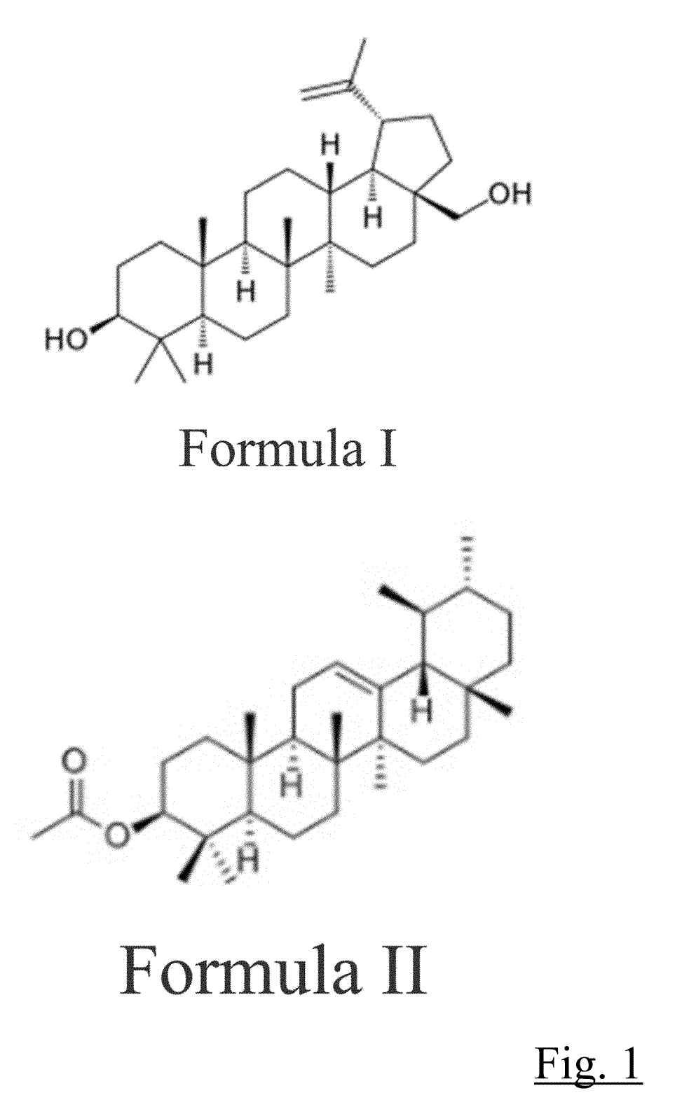

Collect 10 to 25 kilograms powder of natural WMW from mature winter melon using a special removable automatic cleaner. The wax powder is sieved to remove unwanted contaminants and chips. Then, the powder was extracted with distilled water and 95% ethanol. The extract was analyzed by high performance liquid chromatography and confirmed by the method of the literature (High Performance Liquid Chromatography of Triterpenols, Gerard J. Niemann and Wim J. Baas Journal of chromatographic science 16 (6): 260-262., June 1978). The triterpenoids were also analyzed by thin layer chromatography (TLC) and color reaction with carbazole. The results were confirmed by retention time and fragments with gas chromatography and mass spectrometry (GC-MS). The results showed that WMW contained a large amount of Triterpenoids (30-55%) and triterpeneacetal (about 10%-20%), also contain a small amount of aliphatic hydrocarbons. The nanostructure of the WMW was observed using microscopy, and the main superfines could be found. Most of the structure consists of tiny bundles (FIG. 1).

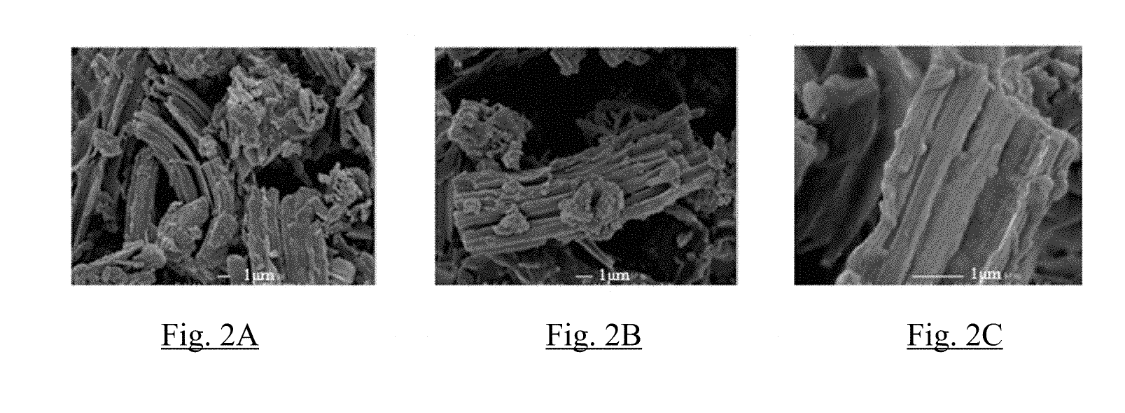

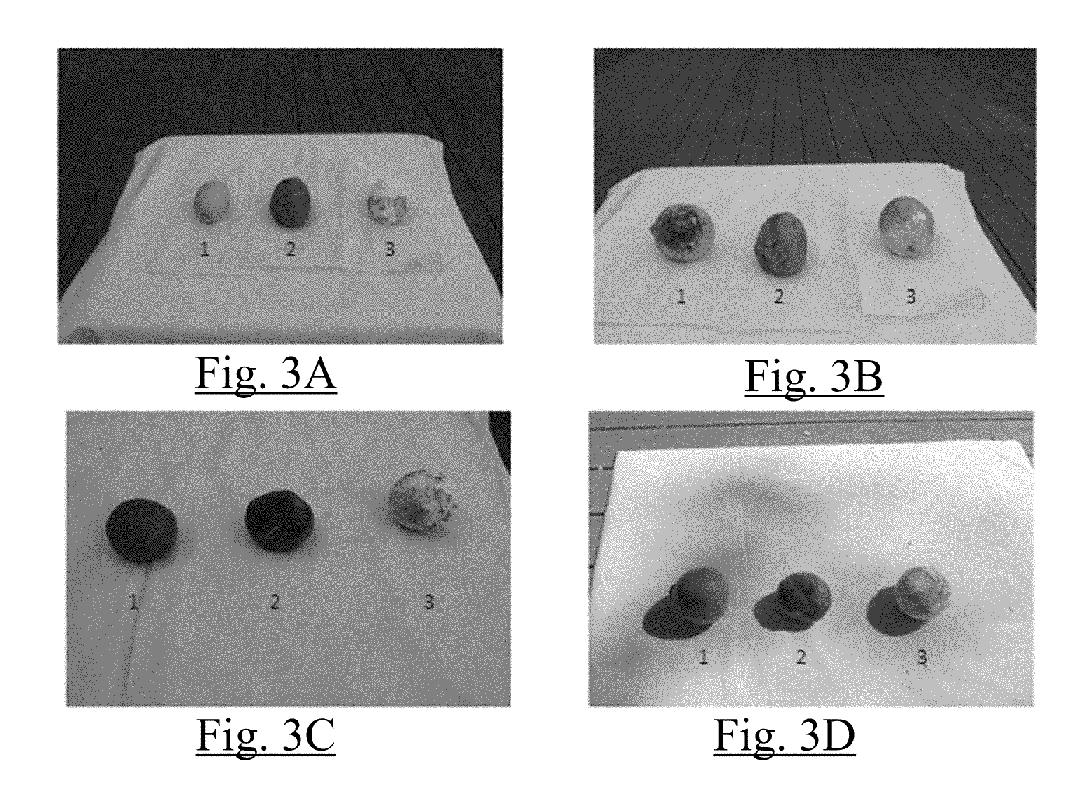

By experiments we tested whether coatings, including that with WMW, on some common fruits have the effect of protecting the fruit from fungal decay. One experiment was to wrap the lemon with WMW, the experiments were carried out in a well ventilated room at the temperature of 15 to 27° C. with a humidity range of 30% to 90%. The results showed that the coating would prevent the decay effect of lemons by the common rotten fungus green moldisewis type 3. Even partially rotten lemons can be protected by WMW coatings as compared to uncoated samples, as shown in FIGS. 2A-B.

Similar results have been obtained from the same experiments on oranges, WMW also exerted an antifungal protection on oranges, as shown in FIG. 2C-D.

Common solvents: 8 common solvents were studied. They are: acetone (A), ethanol (B), cyclohexane (C), dimethyl sulfoxide (D), dichloromethane (E), chloroform (F), mineral oil (G) and distilled water (H). The results showed that distilled water (H) does not dissolve WMW at all. Dimethyl sulfoxide (D), chloroform (F) and mineral oil (G) readily dissolve WMW, the solubilities of WMW in these three solvents were very high. On the other hand, acetone (A), cyclohexane (C) and dichloromethane (E) only partially dissolved WMW, solubilities of WMW were low in these solvents. These results are very useful in the purification of WMW, as well as in researches and WMW applications.

### Embodiment 2: Preparation of Artificial WMW Powder

On the basis of the above research, we prepared “artificial WMW powder”, named “Guaguoxian”, which is composed of 40% Betulin (which is illustrated as Formula I in FIG. 1), 15% α-Amyrin acetate (which is illustrated as Formula II in FIG. 1), and 45% of beeswax, all by weight of total composition, by spray drying of their solution. The product had an ultrastructure similar to that of natural WMW.

The synthesized WMW powder was sprayed on the wax gourds with their wax layer removed, and the antiseptic ability of the artificial WMW powder was compared with the natural WMW. The experimental results showed that the artificial WMW powder and the natural WMW had the same preventive effect on the decay of the wax gourd body.

### Embodiment 3: Microbiological Analysis of Antibacterial and Antifungal Effects of Artificial WMW Powder

The antibacterial activities of the artificial WMW powder against Escherichia coli and Staphylococcus aureus were examined according to the method provided by the literature (CRAMP Analogues Having Potent Antibiotic Activity against Bacterial, Fungal, and Tumor Cells without Hemolytic Activity, Shin S Y, Kang S w, Lee D G, Eom S H, Song W K, Kim J I., BiochemBiophys Res Commun, 2000 Sep. 7; 275(3) 904-909). E. coli and S. aureus were cultured at different concentrations of artificial WMW at 37° C. for 20 h. and the minimum inhibitory concentration (MIC) was determined. The results showed that the artificial WMW powder had minimal inhibition concentrations (MIC) against E. coli and S. aureus at 6.4 μM and 14 μM, respectively.

The antifungal activity of artificial WMW powder was determined by Aspergillus fumigatus. A. fumigatus and different concentrations of artificial WMW powder were incubated at 37° C. for 20 h, and the minimum inhibitory concentration (MIC) was determined. The results showed that the MIC of artificial WMW powder against A. fumigatus was 32 μM.

The above results indicate that the artificial WMW powder proposes by the present invention has strong antibacterial and fungal activity.

### Embodiment 4: Antiseptic Effect of Artificial WMW on Fruits and Grains

The artificial WMW powder of the present invention is used for the preservation of the following fruits and grains: the Winter melon containing the intact natural WMW layer as the positive control 1 (+), and the sample washed with 0.1% hydrogen peroxide as the positive control 2 (+), the surface The bare melon with the wax powder completely removed as a negative control (−): 1. Citrus fruits such as oranges, tangerines, lemons, limes and grapefruits; 2. Other edible fruits such as apples, pears, melons, peaches and others; 3. Grains such as wheat, rice, corn and others; 4. Beans and other crops.

The results showed that the use of the artificial WMW powder of the present invention can provide a longer protection period.

It should be noted that the corrosion protection properties of MWM depend mainly on environmental factors such as temperature, humidity and ventilation. The data obtained in the experimental observations were obtained in a well ventilated room at 15° C. to 27° C. and a humidity range of 30% to 90%. However, the use of WMW can increase the storage time of the fruits and crops listed above by 4 to 20 times, with large differences between different fruits and crops.

### Embodiment 5: Safety Test of Artificial Winter WMW Powder

The artificial WMW powder of the present invention was analyzed for its safety by a large number of toxicity tests and tests, the results showed that the artificial WMW powder of the present invention is safe in use. The hemolysis assay of human red blood cells was negative, and the Ames test showed no carcinogenic activity of the present invention.

### Embodiment 6: Application of Artificial WMW Powder in the Treatment of Diabetic Wounds

Using the rat model of diabetic wound infection as described by J J Mendes et al. (João J Mendes*, Clara I Leandro, Dolores P Bonaparte, and Andreia L Pinto, Comparative Medicine, Vol 62, No. 1, February 2012, Pages 37-48), the antimicrobial activity of WMW was studied, with beeswax powder as a negative control.

The experimental results showed that the wound area was reduced by 20˜30% 9˜10 days after applying WMW, while the negative control group using beeswax powder reduced the wound area by 5%0 or less. This result indicates that WMW treats diabetic wounds effectively.

### Embodiment 7: Anti-Microbial Treatment for Diabetic Foot Ulcer

An amount of 50 mg to 200 mg of purified and sterilized winter melon wax (WMW) powder was filled into a 7 cm×9.25 cm rectangular teabag, and the powder was spreader into a thin and even layer inside the teabag. The teabag was closed and readied for application to diabetic foot ulcer.

The WMW powder bag was placed over the diabetic foot ulcer wound and covered with a slightly larger rectangular protective plaster to securely fix it on the skin. The WMW powder bag can be changed every twenty-four (24) hours. The area of the ulcer wound was then measured every three days for a 21-day treatment regiment.

In one case, the diabetic foot ulcer wound was treated for 41 days by this protocol to a 64 years old male diabetic patient with foot ulcer. No adverse event was observed during and after the treatment. The area of infection of the diabetic foot ulcer was measured and found to reduced by 12 to 16 percent, suggesting the effective anti-microbial and anti-infectious activity of the WMW powder treatment.

The skilled person will be aware of a range of possible modifications of the various embodiments described above. Accordingly, the present invention is defined by the claims and their equivalents.

What is claimed is:

1. A method of treating produce to reduce the amount of microbial contamination on the surface of the produce and to reduce spoilage of the produce, comprising contacting the surface of the produce with a compound comprising:
triterpenenol in concentration from 30-55%;
triterpenenol acetate in concentration from 10%-20%, and
wax in concentration from 35-60%.

2. The method of claim 1, wherein the triterpenenol is Betulin or a structural analog thereof.

3. The method of claim 1, wherein the triterpenenol acetate is α-Amyrin acetate, or a structural analog thereof.

4. The method of claim 1, wherein the wax is beeswax.

5. The method of claim 1, wherein the amount of compound that is applied to the produce is between 0.0001% to 5% of weight of the produce.

6. The method of claim 1, wherein the amount of compound that is applied to the produce is between 0.01% to 2.5% of the weight of the produce.

7. The method of claim 1, wherein the compound is applied to the surface of the produce.

8. The method or creating a powder for preserving produce, the method comprising:
extracting triterpenenol from a winter melon or a winter melon extract;
extracting triterpenenol acetate from a winter melon or a winter melon extract;
obtaining wax; and
combining triterpenenol in concentration from 30-55% with triterpenenol acetate in concentration from 10%-20% and wax in concentration from 35-60% to form the powder.

9. The method of claim 8, wherein the triterpenenol is Betulin or a structural analog thereof.

10. The method of claim 8, wherein the triterpenenol acetate is α-Amyrin acetate, or a structural analog thereof.

11. The method of claim 8, wherein the wax is beeswax.
